(19) United States
(12) Patent Application Publication
(10) Pub. No.: US 2011/0058810 A1
(43) Pub. Date: Mar. 10, 2011

(54) OPTICAL NETWORK UNIT (ONU) AND METHOD OF OPERATING THE ONU

(75) Inventors: Mun Seob LEE, Daejeon (KR); Dongsoo Lee, Gwangju (KR); Byung-Tak Lee, Suwon-si (KR); Geun Yong Kim, Goyang-si (KR); Hark Yoo, Gwangju (KR); Sung Chang Kim, Gwangju (KR); Youngsuk Lee, Gwangju (KR)

(73) Assignee: Electronic and Telecommunications Research Institute, Daejeon (KR)

(21) Appl. No.: 12/876,689

(22) Filed: Sep. 7, 2010

(30) Foreign Application Priority Data
Sep. 7, 2009 (KR) 10-2009-0083848
Nov. 30, 2009 (KR) 10-2009-0116653

(51) Int. Cl. H04J 14/00

(52) U.S. Cl. 398/45

(57) ABSTRACT

Provided is an Optical Network Unit (ONU) and a method of operating the ONU. The ONU may include: a measurement unit to measure a downstream optical signal strength of downstream data received from an Optical Line Termination (OLT) via an optical splitter; a determination unit to determine an upstream optical signal strength based on the measured downstream optical signal strength; and a communication unit to transmit, to the OLT via the optical splitter, upstream data generated based on the determined upstream optical signal strength.

### CROSS-REFERENCE TO RELATED APPLICATIONS

This application claims the benefit of Korean Patent Application No. 10-2009-0083848, filed on Sep. 7, 2009, and Korean Patent Application No. 10-2009-0116653, filed on Nov. 30, 2009, in the Korean Intellectual Property Office, the disclosures of which are incorporated herein by reference.

### BACKGROUND

1. Field of the Invention

Embodiments of the present invention relate to an Optical Network Unit (ONU) and a method of operating the ONU, and more particularly, to an ONU that may control an upstream optical signal strength of upstream data based on a downstream optical signal strength of downstream data, so that an Optical Line Termination (OLT) may receive the upstream data at a constant optical signal strength, and a method of operating the ONU.

2. Description of the Related Art

A next generation communication needs a Fiber To The Home (FTTH) of installing an optical line even in a home in order to more rapidly transmit large information to subscribers. However, the FTTH needs a great amount of costs to replace an existing copper wire-based subscriber network with an optical network. Accordingly, a Passive Optical Network (PON) system is proposed as an alternative solution to construct an inexpensive optical network.

The PON system generally includes an Optical Line Termination (OLT), an optical splitter, and Optical Network Units (ONUs). The OLT and the optical splitter may be connected to each other using a single optical line. The optical splitter and the ONUs may be connected to each other in a one-to-N star topology. Here, N denotes a natural number.

Accordingly, the OLT may transmit downstream data to a single ONU via the optical splitter, and may receive upstream data from the ONU via the optical splitter. In this case, a first path between the OLT and a first ONU, and a second path between the OLT and a second OLU may cause a path difference. Due to the path difference, a to transmission strength, a loss amount, and a phase between data transmitted via the first path and data transmitted via the second path may vary.

Accordingly, due to the path difference, a signal strength for each upstream data transmitted from each of ONUs to the OLT may be different, and a receive sensitivity may be deteriorated.

### SUMMARY

An aspect of the present invention provides an Optical Network Unit (ONU) that may control an upstream optical signal strength based on a loss signal of downstream data, and may transmit upstream data generated based on the controlled upstream optical signal strength, so that an Optical Line Termination (OLT) may receive the upstream data at a constant optical signal strength, and a method of operating the ONU.

According to an aspect of the present invention, there is provided an ONU including: a measurement unit to measure a downstream optical signal strength of downstream data received from an OLT via an optical splitter; a determination unit to determine an upstream optical signal strength based on the measured downstream optical signal strength; and a communication unit to transmit, to the OLT via the optical splitter, upstream data generated based on the determined upstream optical signal strength.

According to another aspect of the present invention, there is provided a method of operating an ONU, the method including: receiving downstream data from an OLT via an optical splitter to measure a downstream optical signal strength of the downstream data; calculating a loss signal of the downstream data based on the to measured downstream optical signal strength to determine an upstream optical signal strength based on the loss signal; and transmitting, to the OLT via the optical splitter, upstream data generated based on the determined upstream optical signal strength.

### EFFECT

According to embodiments of the present invention, an Optical Network Unit (ONU) may control an upstream optical signal strength based on a loss signal of downstream data, and may transmit upstream data generated based on the controlled upstream optical signal strength, so that an Optical Line Termination (OLT) may receive the upstream data at a constant optical signal strength, and a method of operating the ONU.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a Passive Optical Network (PON) system according to an embodiment of the present invention;

FIG. 2 is a block diagram illustrating a configuration of an Optical Network Unit (ONU) according to an embodiment of the present invention; and

FIG. 3 is a flowchart illustrating a method of operating an ONU according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

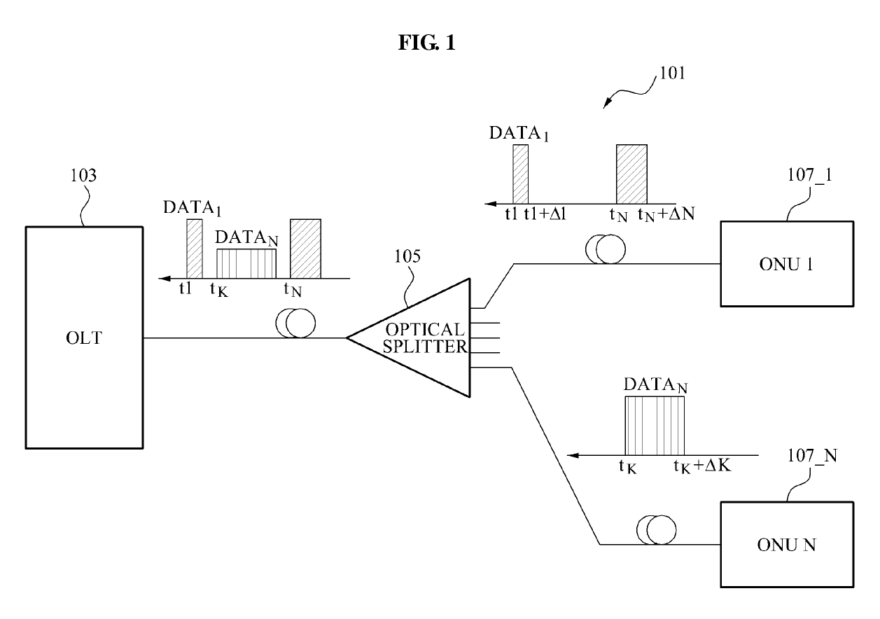

FIG. 1 is a diagram illustrating a configuration of a Passive Optical Network (PON) system 101 according to an embodiment of the present invention.

Referring to FIG. 1, the PON system 101 may include an Optical Line Termination 103, an optical splitter 105, and Optical Network Units (ONU 1, . . . , ONU N) 107_1, . . . , 107_N.

The OLT 103 may be positioned in a central office to transmit a downstream optical signal to the optical splitter 105, or to receive an upstream optical signal from the optical splitter 105 via a single optical line. Wavelengths of the downstream optical signal and the upstream optical signal may be different from each other.

The optical splitter 105 may be positioned in a remote node, and may be connected to the ONUs (1, . . . , N) 107_1, . . . , 107_N in a one-to-N star topology. Here, N denotes a natural number. The optical splitter 105 may communicate with the ONUs (1, . . . , N) 107_1, . . . , 107_N.

Each of the ONUs (1, . . . , N) 107_1, . . . , 107_N may communicate with the optical splitter 105 within a predetermined time slot of each of the ONUs (1, . . . , N) 107_1, . . . , 107_N to transmit and receive optical signals. Here, each of the ONUs (1, . . . , N) 107_1, . . . , 107_N may adjust an optical signal strength of upstream data to be output by measuring a downstream optical signal strength of received downstream data, and by generating and transmitting upstream data based on an upstream optical signal strength determined based on the measured downstream optical signal strength. For example, each of the ONUs (1, . . . , N) 107_1, . . . , 107_N may calculate a loss signal of the downstream data based on the downstream optical signal strength and adjust the upstream optical signal strength of upstream data based on the loss signal, and thereby may compensate for a loss portion occurring during a transfer process using the optical splitter 105. Accordingly, the OLT 103 may receive, from the ONUs (1, . . . , N) 107_1, . . . , 107_N, the upstream data at a constant optical signal strength.

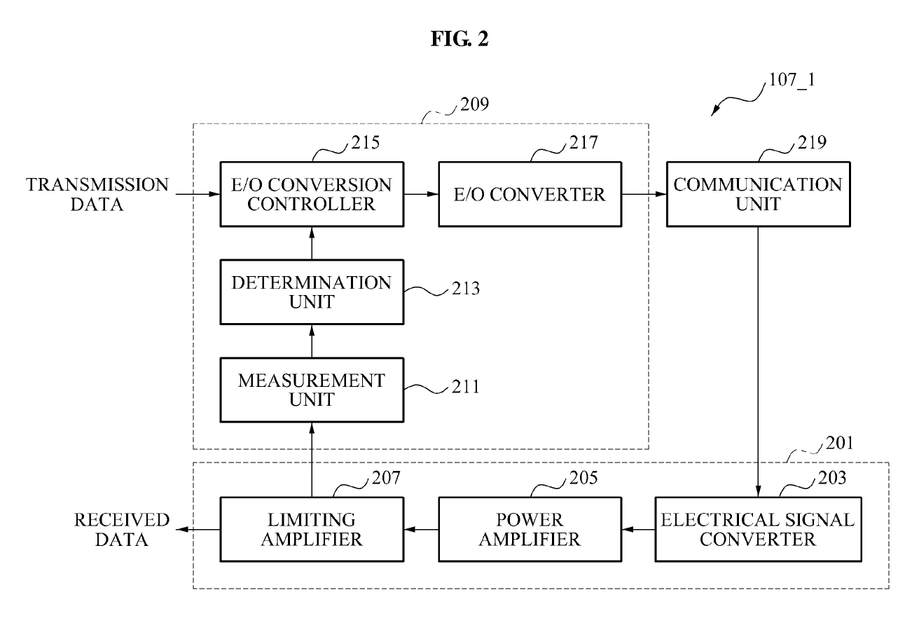

FIG. 2 is a block diagram illustrating a configuration of the ONU (1) 107_1 according to an embodiment of the present invention. The configuration of the ONU (1) 107_1 may be applicable to other ONUs.

Referring to FIGS. 1 and 2, the ONU (1) 107_1 may include a received data processor 201, a transmission data processor 209, and a communication unit 219.

The received data processor 201 may include an electrical signal converter 203, a power amplifier 205, and a limiting amplifier 207.

The electrical signal converter 203 may be, for example, a Photo Diode (PD). The electrical signal converter 203 may convert, to a current signal, an optical signal of downstream data received from the OLT 103 via the optical splitter 105.

The power amplifier 205 may be, for example, a trans-impedance amplifier. The power amplifier 205 may pre-amplify, to a voltage signal, the current signal output from the electrical signal converter 203.

The limiting amplifier 207 may output received data by converting, to a digital voltage signal, the voltage signal output from the power amplifier 205.

The transmission data processor 209 may include a measurement unit 211, a determination unit, an electric-to-optic (E/O) conversion controller 215, and an E/O converter 217.

The measurement unit 211 may measure a downstream optical signal strength of downstream data received from the OLT 103.

The determination unit 213 may determine an upstream optical signal strength based on the measured downstream optical signal strength. Specifically, the determination unit 213 may compare the measured downstream optical signal strength with a predetermined downstream reference strength to calculate a loss signal of the downstream data, and to determine the upstream optical signal strength based on a predetermined upstream reference strength and the loss signal.

For example, the determination unit 213 may determine the upstream optical signal strength by adding up the predetermined upstream reference strength and the loss signal.

The E/O conversion controller 215 may be, for example, a Laser Diode Driver (LDD). The E/O conversion controller 215 may receive transmission data to convert the received transmission data based on the determined upstream optical signal strength, and may transfer the converted transmission data to the E/O converter 217.

The E/O converter 217 may be, for example, a Laser Diode (LD). The E/O converter 217 may convert, to an optical signal, the transmission data, that is, upstream data that is output from the E/O conversion controller 215.

The communication unit 219 may receive, from the OLT 103 via the optical splitter 105, downstream data within a predetermined time slot of the ONU (1) 107_1. The communication unit 219 may transmit, to the OLT 103 via the optical splitter 105 within the predetermined time slot of the ONU (1) 107_1, the upstream data output from the E/O converter 217. Here, the communication unit 219 may include a Wavelength Division Multiplexing (WDM) filter to receive the downstream data by multiplexing the downstream data, or to transmit the upstream data by multiplexing the upstream data.

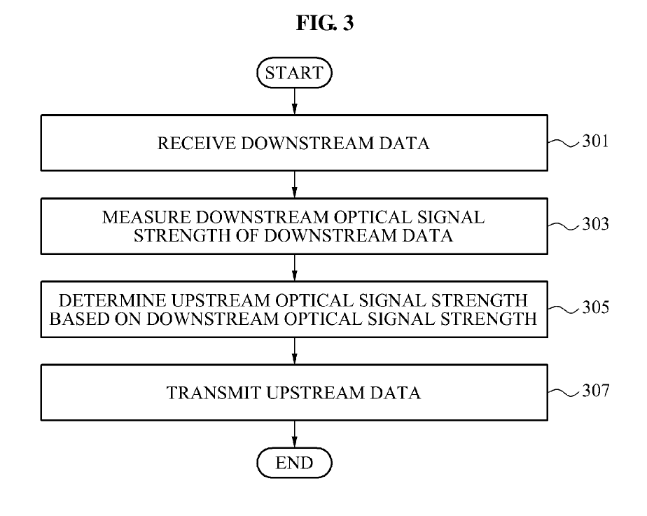

FIG. 3 is a flowchart illustrating a method of operating an ONU according to an embodiment of the present invention.

In operation 301, an ONU may receive downstream data.

Specifically, the ONU may receive downstream data from an OLT via an optical splitter, and may convert an optical signal of the received downstream data to a current signal. The ONU may pre-amplify the current signal to a voltage signal, and may convert the pre-amplified voltage signal to a digital voltage signal.

In operation 303, the ONU may measure a downstream optical signal strength of the received downstream data.

Specifically, the ONU may measure a strength of the downstream data converted to the digital voltage signal.

In operation 305, the ONU may determine an upstream optical signal strength based on the measured downstream optical signal strength.

Specifically, the ONU may calculate a loss signal of the downstream data based on the measured downstream optical signal strength, and may determine the upstream optical signal strength based on the loss signal. For example, the ONU may compare the measured downstream optical signal strength with a predetermined downstream reference strength to calculate the loss signal of downstream data, and to determine the upstream optical signal strength based on a predetermined upstream reference strength and the loss signal.

For example, the ONU may determine the upstream optical signal strength by adding up the predetermined upstream reference strength and the loss signal.

In operation 307, the ONU may transmit the generated upstream data based on the determined upstream optical signal strength.

Specifically, the ONU may receive the transmission data to generate the upstream data based on the determined upstream optical signal strength. The ONU may E/O convert the upstream to an optical signal, and transmit the converted optical signal to the OLT via the optical splitter.

According to embodiments of the present invention, an ONU may control an upstream optical signal strength based on a loss signal of downstream data, and may transmit upstream data generated based on the controlled upstream optical signal strength, so that an OLT may receive the upstream data at a constant optical signal strength, and a method of operating the ONU.

The ONU operation method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code to that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An Optical Network Unit (ONU) comprising:
a measurement unit to measure a downstream optical signal strength of downstream data received from an Optical Line Termination (OLT) via an optical splitter;
a determination unit to determine an upstream optical signal strength based on the measured downstream optical signal strength; and
a communication unit to transmit, to the OLT via the optical splitter, upstream data generated based on the determined upstream optical signal strength.

2. The ONU of claim 1, wherein the determination unit compares the measured downstream optical signal strength with a predetermined downstream reference strength to calculate a loss signal of the downstream data, and to determine the upstream optical signal strength based on a predetermined upstream reference strength and the loss signal.

3. The ONU of claim 1, further comprising:
an electrical signal converter to convert an optical signal of the downstream data to a current signal;
a power amplifier to pre-amplify the current signal to a voltage signal; and
a limiting amplifier to convert the pre-amplified voltage signal to a digital voltage signal.

4. The ONU of claim 1, further comprising:
an electric-to-optic (E/O) converter to E/O convert the upstream data to an optical signal.

5. The ONU of claim 1, wherein the communication unit comprises:
a Wavelength Division Multiplexing (WDM) filter to receive the downstream data by multiplexing the downstream data, or to transmit the upstream data by multiplexing the upstream data.

6. A method of operating an ONU, the method comprising:
receiving downstream data from an OLT via an optical splitter to measure a downstream optical signal strength of the downstream data;
calculating a loss signal of the downstream data based on the measured downstream optical signal strength to determine an upstream optical signal strength based on the loss signal; and
transmitting, to the OLT via the optical splitter, upstream data generated based on the determined upstream optical signal strength.

7. The method of claim 6, wherein the calculating and the determining comprises comparing the measured downstream optical signal strength with a predetermined downstream reference strength to calculate the loss signal, and to determine the upstream optical signal strength based on a predetermined upstream reference strength and the loss signal.

8. The method of claim 6, further comprising:
converting an optical signal of the downstream data to a current signal;
pre-amplifying the current signal to a voltage signal; and
converting the pre-amplified voltage signal to a digital voltage signal.

9. The method of claim 6, further comprising:
E/O converting the upstream data to an optical signal.
